(19) United States
(12) Patent Application Publication
(10) Pub. No.: US 2026/0050926 A1
(43) Pub. Date: Feb. 19, 2026

(54) SYSTEMS AND METHODS FOR VERIFYING FUNDS TRANSFER

(71) Applicant: Capital One Services, LLC, McLean, VA (US)

(72) Inventors: Sneha Anand Yeluguri, Jersey City, NJ (US); Claire Robbins, New York, NY (US); Fayaz Khan, Souderton, PA (US); Jin Yang Loutris, Buffalo Grove, IL (US); Eitan Isser, New York, NY (US); Elsa Maria Davis, Oakton, VA (US)

(21) Appl. No.: 18/806,158

(22) Filed: Aug. 15, 2024

(51) Int. Cl. G06Q 20/42; G06Q 20/38

(52) U.S. Cl. CPC G06Q 20/42; G06Q 20/3821

(57) ABSTRACT

Disclosed embodiments may include a method for verifying funds transfer. The method may include receiving, from a first user device, a request to complete a transfer from a first account to a second account and generating a passphrase for authentication of the transfer. Next, the method may include transmitting, to the first user device, the passphrase for authentication of the transfer, receiving, from a second user device, a shared passphrase for authentication of the transfer, and determining whether the shared passphrase matches at least a portion of the passphrase. In response to determining that the shared passphrase matches at least a portion of the passphrase, the method may include transferring funds from the first account to the second account.

The disclosed technology relates to systems and methods for verifying funds transfer. Specifically, this disclosed technology relates to verifying funds transfer by using a shared passphrase between a sender and recipient prior to transferring the funds to an account.

### BACKGROUND

When a sender transfers funds to a recipient for the first time, the sender may have a lack of confidence that the selected recipient is correct. This lack of confidence can ultimately cause senders to refrain from transferring the funds. Current funds transfer verification methods rely on internal application features for the verification which can keep the confidence level of the senders low.

Accordingly, there is a need for improved systems and methods for verifying funds transfer. Embodiments of the present disclosure are directed to this and other considerations.

### SUMMARY

Disclosed embodiments may include a system for verifying funds transfer. The system may include one or more processors, and memory in communication with the one or more processors and storing instructions that, when executed by the one or more processors, are configured to cause the system to verify funds transfer. The system may receive, from a first user device, a request to complete a transfer from a first account to a second account, generate a passphrase for authentication of the transfer, and transmit, to the first user device, the passphrase for authentication of the transfer. The system may then receive, from a second user device, a shared passphrase for authentication of the transfer and determine whether the shared passphrase matches at least a portion of the passphrase. Then, in response to determining that the shared passphrase matches at least a portion of the passphrase, the system may transfer funds from the first account to the second account.

Disclosed embodiments may include a system for verifying funds transfer. The system may include one or more processors, and memory in communication with the one or more processors and storing instructions that, when executed by the one or more processors, are configured to cause the system to verify funds transfer. The system may receive a notification of a transfer from a transfer verification system, display a first graphical user interface (GUI) comprising an account balance, a status indication associated with the transfer, and a prompt comprising a field for receiving a passphrase, and receive a first passphrase for completing the transfer from a second user device via a first communication channel. Then the system may receive, via field of the first GUI, user input comprising an entered passphrase for completion of the transfer and transmit the entered passphrase to the transfer verification system. Then the system may receive an indication that funds associated with the transfer have transferred to an account associated with the first user device when the entered passphrase for the transfer is verified and display a second GUI comprising the indication and an updated account balance.

Disclosed embodiments may include a system for verifying funds transfer. The system may include one or more processors, and memory in communication with the one or more processors and storing instructions that, when executed by the one or more processors, are configured to cause the system to verify funds transfer. The system may receive, from a first user device, a request to complete a transfer from a first account to a second account and receive, from the first user device, a selected passphrase for authentication of the transfer. Then the system may receive, from a second user device, a shared passphrase for authentication of the transfer and determine whether the shared passphrase matches at least a portion of the selected passphrase. Then in response to determining that the shared passphrase matches at least a portion of the selected passphrase, the system may transfer funds from the first account to the second account.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for verifying funds transfer in accordance with certain embodiments of the disclosed technology.

FIG. 2 is a flow diagram illustrating an exemplary method for verifying funds transfer in accordance with certain embodiments of the disclosed technology.

FIG. 3 is block diagram of an example transfer verification system used to provide verifying funds transfer, according to an example implementation of the disclosed technology.

FIG. 4 is block diagram of an example system that may be used to provide verifying funds transfer, according to an example implementation of the disclosed technology.

### DETAILED DESCRIPTION

Examples of the present disclosure relates to systems and methods for verifying funds transfer. More particularly, the disclosed technology relates to verifying funds transfers by using a shared passphrase between a sender and recipient prior to transferring the funds to an account. The systems and methods described herein utilize, in some instances, graphical user interfaces, which are necessarily rooted in computers and technology. Graphical user interfaces are a computer technology that allows for user interaction with computers through touch, pointing devices, or other means. The present disclosure details using a graphical user interface to interact with user devices to verify passphrases for the funds transfer. This, in some examples, may involve using a passphrase to dynamically change the graphical user interface for authentication for the funds transfer which also involves using separate communication channels. Using a graphical user interface in this way may allow the system to increase the accuracy of selecting and confirming recipients for funds transfers. This is a clear advantage and improvement over prior technologies that that rely solely on internal application features because confirming the passphrase through the graphical user interface of a second user device increases the likelihood that the second user device is permitted to receive the funds transfer. Overall, the systems and methods disclosed have significant practical applications in the verification field because of the noteworthy improvements of the external passcode verification, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

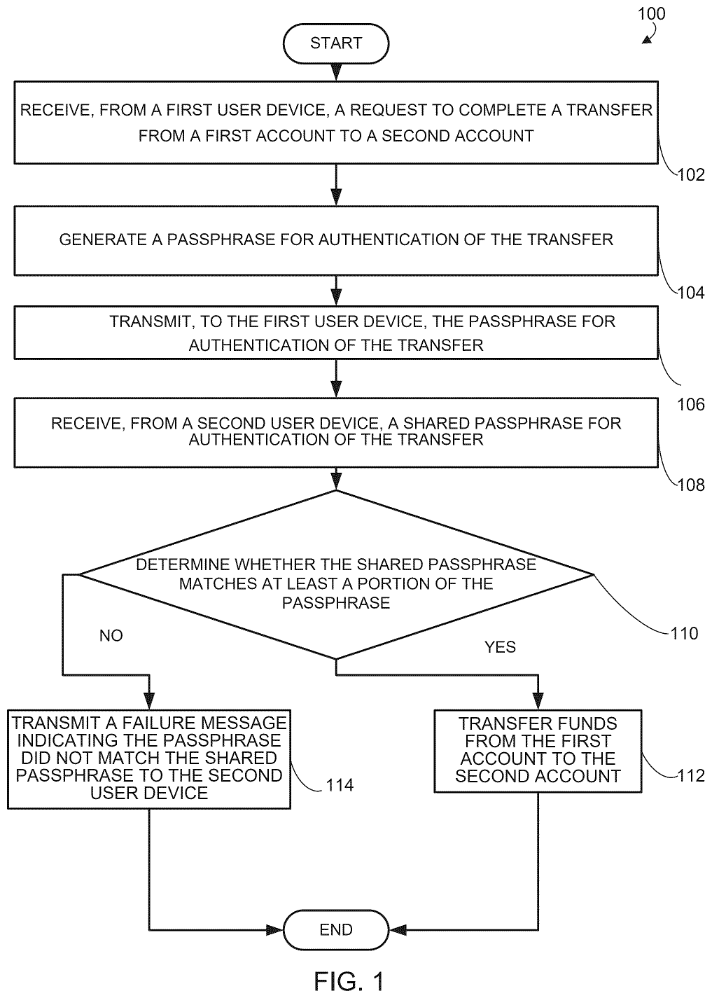

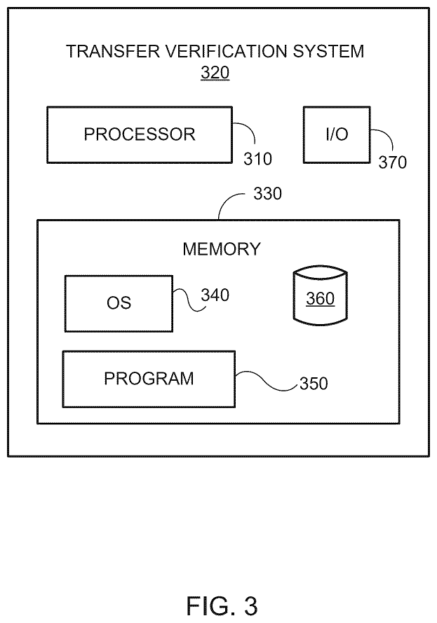

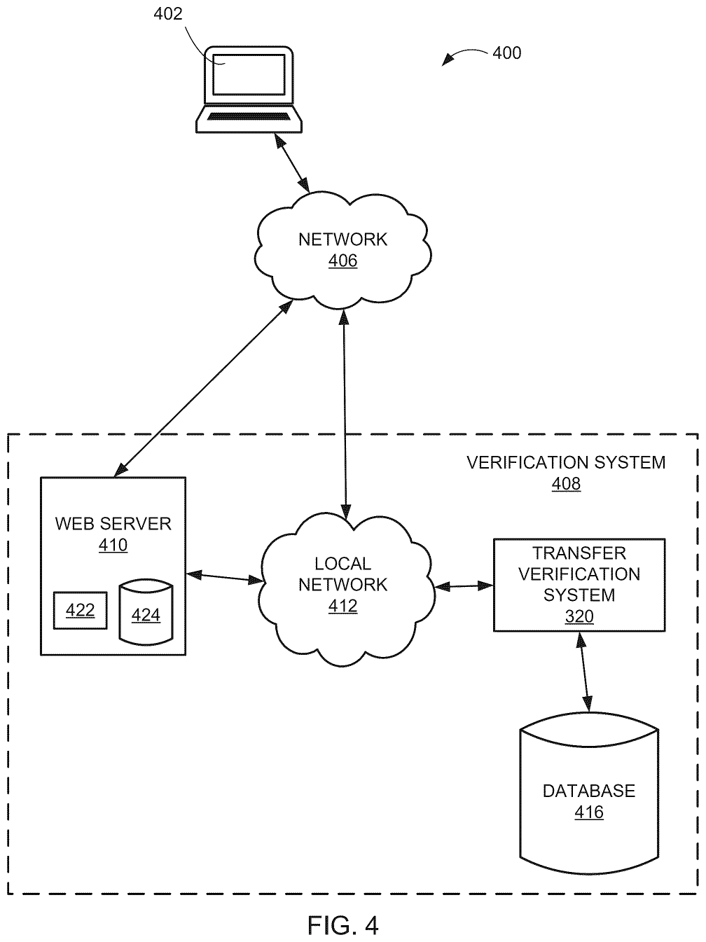

FIG. 1 is a flow diagram illustrating an exemplary method 100 for verifying funds transfer, in accordance with certain embodiments of the disclosed technology. The steps of method 100 may be performed by one or more components of the system 400 (e.g., transfer verification system 320 or web server 410 of verification system 408 or user device 402), as described in more detail with respect to FIGS. 3 and 4.

In block 102, the transfer verification system 320 may receive from a first user device 402, a request to complete a transfer from a first account to a second account. The transfer verification system 320 may require authentication of the first user device 402 prior to processing the request to complete the transfer. The transfer verification system 320 may receive from the first user device 402, login credentials for authentication of the first account and authenticate the first user device 402 to access the first account by using the login credentials. The transfer verification system 320 may generate a graphical user interface (GUI) comprising an acceptance of the login credentials or a confirmation message of the authentication of the first user device 402. The request can include an intended recipient, an amount for the transfer, a description for the transfer, or combinations thereof.

In block 104, the transfer verification system 320 may generate a passphrase for authentication of the transfer. The transfer verification system 320 may use a random passphrase generator to create a sequence that meets multiple passphrase requirements. For example, the multiple passphrase requirements can include the sequence having a length larger than a minimum length requirement (or minimum passphrase requirement) and with specific types of letters, numbers, special characters, etc. In other embodiments, the first user device 402 or a first user may create a passphrase instead of having the passphrase generated. The transfer verification system 320 may determine whether the selected passphrase for authentication of the transfer meets the minimum passphrase requirement by comparing the selected passphrase to multiple passphrase requirements. In response to determining the selected passphrase does not meet the minimum passphrase requirement, the transfer verification system 320 may generate or modify the GUI to include a notification that the selected passphrase does not meet the minimum passphrase requirement. The transfer verification system 320 may then transmit the modified GUI to the first user device 402 for display. If the transfer verification system 320 determines that the selected passphrase does meet the minimum passphrase requirement and the multiple passphrase requirements, then the process can move to block 106.

In block 106, the transfer verification system 320 may transmit to the first user device 402, the passphrase for authentication of the transfer. The first user device 402 may then use a separate communication channel to transmit the passphrase to a second user device 402. In a non-limiting example, the first user device 402 may send a text message, an email, a Facebook messenger message, a WhatsApp message, or any other communication in the art with the passphrase to a second user at the second user device 402. The first user may also use non-digital communication channels such as sending a letter with the passphrase to the second user (or other communication channels known in the art). Because the first user device 402 sends the passphrase to the second user device 402 using a separate communication channel, the first user may have greater confidence that the intended recipient will be the correct recipient due to the requirement of the second user having to enter a shared passphrase that must match the generated or shared passphrase.

In block 108, the transfer verification system 320 may receive from the second user device 402, a shared passphrase for authentication of the transfer. The transfer verification system 320 may require authentication of the second user device 402 prior to processing the request to complete the transfer. The transfer verification system 320 may receive from the second user device 402, login credentials for authentication of a second account associated with the second user device 402 and authenticate the second user device 402 to access the second account by using the login credentials. The transfer verification system 320 may generate a second graphical user interface (GUI) comprising an acceptance of the login credentials or a confirmation message of the authentication of the second user device 402. In this non-limiting example, the shared passphrase that the second user device 402 sends to the transfer verification system 320 should be the passphrase that the first user at the first user device 402 shared or transmitted via the separate communication channel to the second user at the second user device 402.

In block 110, the transfer verification system 320 may determine whether the shared passphrase matches at least a portion of the passphrase by comparing the shared passphrase against the passphrase. The comparing can include determining a number of matching characters between the shared passphrase (and comparing the number of matching characters to a threshold number to determine a match) and the passphrase, determining a distance between the shared passphrase and the passphrase (and comparing the distance to a threshold distance to determine a match, where a lower distance than the threshold distance establishes a sufficient match). Other comparing methods known in the art to determine if there is a sufficient match between the shared passphrase and the passphrase. The transfer verification system 320 may also require an exact match to proceed to block 112. Additionally, in some embodiments, the transfer verification system 320 must receive the shared passphrase within a threshold time period, or the transfer verification system 320 can deny the transfer and will not proceed to block 112 (and can instead proceed to block 114 to generate a failure message).

In block 112, the transfer verification system 320 may transfer funds from the first account to the second account. The transfer from the first account to the second account can be a first transfer request between the first account and the second account. In some embodiments, the transfer verification system 320 may modify the first GUI or the second GUI to include a notification of the transfer completion and transmit the modified first GUI or the modified second GUI to the first user device 402 or the second user device 402, respectively.

In block 114, the transfer verification system 320 may transmit a failure message indicating the passphrase did not match the shared passphrase to the second user device 402 and the exemplary process may terminate. The transfer verification system 320 may allow for the second user device 402 to send additional shared passphrases to the transfer verification system 320 as additional attempts to match the shared passphrase to the passphrase. The transfer verification system 320 may limit the number of attempts to match the shared passphrase to the passphrase. The transfer verification system 320 may receive from the first user device 402, a request for a second passphrase for authenticating the transfer. The transfer verification system 320 may generate the second passphrase for authenticating the transfer. The transfer verification system 320 may transmit to the first user device 402, the second passphrase for authentication of the transfer and receive, from the second user device 402, a second shared passphrase for authentication of the transfer. The transfer verification system 320 may authenticate the transfer by determining whether the second shared passphrase matches at least a portion of the second passphrase. The transfer verification system 320 may, in response to determining that the second shared passphrase matches at least a portion of the second passphrase, transfer funds from the first account to the second account. In response to determining that the second shared passphrase does not match at least a portion of the second passphrase, the transfer verification system 320 may transmit a second failure message indicating the second passphrase did not match the second shared passphrase to the second user device. The transfer verification system 320 may then receive from the first user device 402, a request for a third passphrase for authenticating the transfer and generate the third passphrase for authenticating the transfer. The transfer verification system 320 may transmit to the first user device 402, the third passphrase for authentication of the transfer and receive, from the second user device 402, a third shared passphrase for authentication of the transfer. Then, the transfer verification system 320 may authenticate the transfer by determining whether the third shared passphrase matches at least a portion of the third passphrase and in response to determining that the third shared passphrase matches at least a portion of the third passphrase, transfer funds from the first account to the second account and move to block 112.

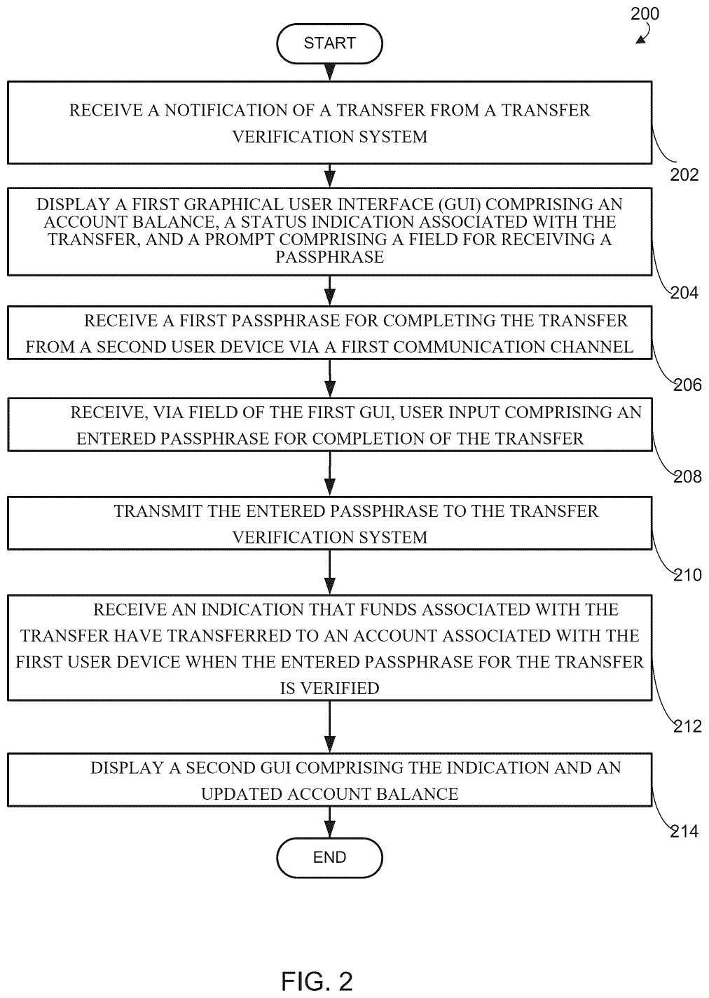

FIG. 2 is a flow diagram illustrating an exemplary method 200 for verifying funds transfer, in accordance with certain embodiments of the disclosed technology. The steps of method 200 may be performed by one or more components of the system 400 (e.g., transfer verification system 320 or web server 410 of verification system 408 or user device 402), as described in more detail with respect to FIGS. 3 and 4.

Method 200 of FIG. 2 is similar to method 100 of FIG. 1, except that method 200 is from the perspective of the second user device 402 (from method 100 of FIG. 1) and may not include blocks 102, 104, and 106 of method 100. However, blocks 210, 212 are different from blocks 108 and 112 and are described below. Additional blocks 202, 204, 206, 208, and 214 are also described below.

In block 202, a first user device 402 may receive a notification of a transfer from a transfer verification system 320. As outlined in block 102 method 100 in FIG. 1, the transfer may be initiated by a second user device 402 (referred to in method 100, as the first user device 402, but will be referred to here as the second user device 402 in method 200). The transfer verification system 320 may require authentication of the first user device 402 prior to processing the request to complete the transfer. The transfer verification system 320 may receive from the first user device 402, login credentials for authentication of the first account and authenticate the first user device 402 to access the first account by using the login credentials. The transfer verification system 320 may generate a first graphical user interface (GUI) comprising an acceptance of the login credentials or a confirmation message of the authentication of the first user device 402.

In block 204, the first user device 402 may modify the first GUI to include an account balance, a status indication associated with the transfer, and a prompt including a field for receiving a passphrase. The account balance can be associated with an account of a user at the first user device 402. The status indication can include an awaiting passphrase status, verifying passphrase status, transferring funds status, a completed status, or other statuses known in the art. The prompt can include a request for a passphrase to authenticate the user for the transfer.

In block 206, the first user device 402 may receive a first passphrase for completing the transfer from a second user device 402 via a first communication channel (as outlined in method 100, block 106) (where the first user device 402 is the second user device 402 in this example and the second user device 402 is the first user device 402 in this example). The first passphrase can be generated by the transfer verification system 320 as outlined in method 100, block 104. In other embodiments, the first passphrase can be created by a second user at the second user device 402 as outlined in method 100, block 104. The first communication channel can include the separate communication channels outlined in method 100, block 106.

In block 208, the first user device 402 may receive, via the field of the first GUI, user input comprising an entered passphrase for completion of the transfer. The entered passphrase can be the first passphrase received from the second user device 402. By entering the first passphrase as the entered passphrase, the transfer verification system 320 may verify that the user at the first user device 402 has authorization to receive the transfer of funds.

In block 210, the first user device 402 may transmit the entered passphrase to the transfer verification system 320 (as outlined in method 100, block 108) (where the first user device 402 is the second user device 402 in this example and the second user device 402 is the first user device 402 in this example). The transfer verification system 320 may determine whether a passphrase matches the entered passphrase as outlined in method 100, block 110. If the transfer verification system 320 determines that the passphrase matches the entered passphrase, then the process can move to block 212. Otherwise, as outlined in method 100, block 114, the first user device 402 may receive a failure message form the transfer verification system 320 indicating the entered passphrase did not match the passphrase generated by the transfer verification system 320 or created by the second user device 402 (and the transfer verification system 320 may proceed as outlined in method 100, block 114 to allow additional attempts or generate a second passphrase) (not repeated herein for brevity).

In block 212, the first user device 402 may receive an indication that funds associated with the transfer have transferred to an account associated with the first user device 402 when the entered passphrase for the transfer is verified. The transfer verification system 320 may verify the transfer as outlined in method 100, block 110. The transfer verification system 320 may transfer the funds to the account associated with the first user device 402 as outlined in method 100, block 110. In block 214, the first user device 402 may display a second GUI comprising the indication and an updated account balance. The updated account balance can include the funds added to the account from the transfer. In some embodiments, the transfer verification system 320 may generate a second graphical user interface (GUI) to include a notification of the transfer completion and transmit the second GUI to the second user device 402. Then, the exemplary process may terminate.

FIG. 3 is a block diagram of an example transfer verification system 320 used to verify funds transfer according to an example implementation of the disclosed technology. According to some embodiments, the user device 402 and web server 410, as depicted in FIG. 4 and described below, may have a similar structure and components that are similar to those described with respect to transfer verification system 320 shown in FIG. 3. As shown, the transfer verification system 320 may include a processor 310, an input/output (I/O) device 370, a memory 330 containing an operating system (OS) 340 and a program 350. In certain example implementations, the transfer verification system 320 may be a single server or may be configured as a distributed computer system including multiple servers or computers that interoperate to perform one or more of the processes and functionalities associated with the disclosed embodiments. In some embodiments transfer verification system 320 may be one or more servers from a serverless or scaling server system. In some embodiments, the transfer verification system 320 may further include a peripheral interface, a transceiver, a mobile network interface in communication with the processor 310, a bus configured to facilitate communication between the various components of the transfer verification system 320, and a power source configured to power one or more components of the transfer verification system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the transfer verification system 320 may include one or more storage devices configured to store information used by the processor 310 (or other components) to perform certain functions related to the disclosed embodiments. In one example, the transfer verification system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The transfer verification system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the transfer verification system 320 may include the memory 330 that may include one or more programs 350 to perform one or more functions of the disclosed embodiments. For example, in some embodiments, the transfer verification system 320 may additionally manage dialogue and/or other interactions with the customer via a program 350.

The processor 310 may execute one or more programs 350 located remotely from the transfer verification system 320. For example, the transfer verification system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a transfer verification system database 360 for storing related data to enable the transfer verification system 320 to perform one or more of the processes and functionalities associated with the disclosed embodiments.

The transfer verification system database 360 may include stored data relating to status data (e.g., average session duration data, location data, idle time between sessions, and/or average idle time between sessions) and historical status data. According to some embodiments, the functions provided by the transfer verification system database 360 may also be provided by a database that is external to the transfer verification system 320, such as the database 416 as shown in FIG. 4.

The transfer verification system 320 may also be communicatively connected to one or more memory devices (e.g., databases) locally or through a network. The remote memory devices may be configured to store information and may be accessed and/or managed by the transfer verification system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The transfer verification system 320 may also include one or more I/O devices 370 that may comprise one or more interfaces for receiving signals or input from devices and providing signals or output to one or more devices that allow data to be received and/or transmitted by the transfer verification system 320. For example, the transfer verification system 320 may include interface components, which may provide interfaces to one or more input devices, such as one or more keyboards, mouse devices, touch screens, track pads, trackballs, scroll wheels, digital cameras, microphones, sensors, and the like, that enable the transfer verification system 320 to receive data from a user (such as, for example, via the user device 402).

In examples of the disclosed technology, the transfer verification system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the transfer verification system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the transfer verification system 320 may include a greater or lesser number of components than those illustrated.

FIG. 4 is a block diagram of an example system that may be used to view and interact with verification system 408, according to an example implementation of the disclosed technology. The components and arrangements shown in FIG. 4 are not intended to limit the disclosed embodiments as the components used to implement the disclosed processes and features may vary. As shown, verification system 408 may interact with a user device 402 via a network 406. In certain example implementations, the verification system 408 may include a local network 412, a transfer verification system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the verification system 408. In some embodiments, the user device 402 may include or incorporate electronic communication devices for hearing or vision impaired users.

Users may include individuals such as, for example, subscribers, clients, prospective clients, or customers of an entity associated with an organization, such as individuals who have obtained, will obtain, or may obtain a product, service, or consultation from or conduct a transaction in relation to an entity associated with the verification system 408. According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The verification system 408 may be associated with and optionally controlled by one or more entities such as a business, corporation, individual, partnership, or any other entity that provides one or more of goods, services, and consultations to individuals such as customers. In some embodiments, the verification system 408 may be controlled by a third party on behalf of another business, corporation, individual, partnership. The verification system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that are authenticated by the transfer verification system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the verification system 408 to interact with one another and to connect to the network 406 for interacting with components in the system 400 environment. In some embodiments, the local network 412 may include an interface for communicating with or linking to the network 406. In other embodiments, certain components of the verification system 408 may communicate via the network 406, without a separate local network 406.

The verification system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access verification system 408 using the cloud computing environment. User device 402 may be able to access verification system 408 using specialized software. The cloud computing environment may eliminate the need to install specialized software on user device 402.

In accordance with certain example implementations of the disclosed technology, the verification system 408 may include one or more computer systems configured to compile data from a plurality of sources the transfer verification system 320, web server 410, and/or the database 416. The transfer verification system 320 may correlate compiled data, analyze the compiled data, arrange the compiled data, generate derived data based on the compiled data, and store the compiled and derived data in a database such as the database 416. According to some embodiments, the database 416 may be a database associated with an organization and/or a related entity that stores a variety of information relating to customers, transactions, ATM, and business operations. The database 416 may also serve as a back-up storage device and may contain data and information that is also stored on, for example, database 360, as discussed with reference to FIG. 3.

### Example Use Case

The following example use case describes an example of a typical user flow pattern. This section is intended solely for explanatory purposes and not in limitation.

In one example, a customer John needs to send funds to a recipient Jane with his cell phone, a user device 402. In this example, John has never sent funds to Jane before. Company, the banking company can offer online services that John can utilize to complete the funds transfer request. To gain access to the account, John may send, via the user device 402, a login request with authentication information for his account to the transfer verification system 320. The transfer verification system 320 may then determine whether the authentication information matches data associated with an account belonging to John. The transfer verification system 320, in response to determining that the authentication information matches at least a portion of the data associated with the account of John's, may authorize the user device 402 to access the account of the user. The transfer verification system 320 may then receive from John's cell phone, the user device 402, a request to complete a transfer from John's account to Jane's account. The transfer verification system 320 may then generate a passphrase for the authentication of the transfer, which is then transmitted to the John's cell phone, the user device 402 for authentication of the transfer. John may then transmit via a separate channel such as a text message or email the passcode to Jane's cell phone, a second user device 402. The transfer verification system 320 may then receive from Jane's cell phone, the second user device 402, the passcode shared with her. The transfer verification system 320 may take the shared passcode received from Jane's cell phone 402 and compare it to the passcode generated and transmitted to John's cell phone 402. If the transfer verification system 320 determines that the shared passphrase matches at least a portion of the passphrase, then the transfer verification system 320 may transfer the funds from John's account to Jane's account. If the transfer verification system 320 determines that the shared passphrase does not match at least a portion of the passphrase, then the transfer verification system 320 may transmit a failure message indicating the passphrase did not match the shared passphrase to the Jane's cell phone 402 or to John's cell phone 402.

In other examples, the transfer verification system 320 may allow Jane's cell phone 402 to send additional shared passphrases as additional attempts to match the shared passphrases to the generated passphrase if the transfer verification system 320 determines that the shared passphrase does not match at least a portion of the passphrase. The transfer verification system 320 may limit the number of attempts to match the shared passphrases to the generated passphrase. If the maximum number of attempts of trying to match the shared passphrase to the generated passphrase is reached, the transfer verification system 320 may transmit a message to John's cell phone 402 requesting if a new passphrase should be generated and transmitted to John's cell phone 402. The above process may then be repeated (of John sending the new passphrase to Jane's cell phone 402 and Jane's cell phone 402 transmitting the new shared passphrase to the transfer verification system 320 for matching).

In some examples, disclosed systems or methods may involve one or more of the following clauses:

Clause 1: A transfer verification system comprising: one or more processors; and memory in communication with the one or more processors and storing instructions that, when executed by the one or more processors, are configured to cause the transfer verification system to: receive, from a first user device, a request to complete a transfer from a first account to a second account; generate a passphrase for authentication of the transfer; transmit, to the first user device, the passphrase for authentication of the transfer; receive, from a second user device, a shared passphrase for authentication of the transfer; determine whether the shared passphrase matches at least a portion of the passphrase; and in response to determining that the shared passphrase matches

Clause 2: The transfer verification system of clause 1, wherein the instructions are further configured to cause the transfer verification system to: generate a graphical user interface (GUI) comprising a notification of the transfer; and transmit the GUI to the second user device for display.

Clause 3: The transfer verification system of clause 1, wherein the passphrase is created by a first user and received from the first user device.

Clause 4: The transfer verification system of clause 1, wherein the instructions are further configured to cause the transfer verification system to: receive, from the first user device, login credentials for authentication of the first account; and authenticate the first user device to access the first account by using the login credentials.

Clause 5: The transfer verification system of clause 1, wherein the instructions are further configured to cause the transfer verification system to: receive, from the second user device, login credentials for authentication of the second account; and authenticate the second user device to access the second account by using the login credentials, wherein transferring funds from the first account to the second account is in response to the authenticating the second user device and determining whether the shared passphrase matches at least the portion of the passphrase.

Clause 6: The transfer verification system of clause 1, wherein the instructions are further configured to cause the transfer verification system to: determine whether the passphrase is received within a threshold time period; and deny the transfer when the shared passphrase is not received within the threshold time period.

Clause 7: The transfer verification system of clause 1, wherein the instructions are further configured to cause the transfer verification system to: in response to determining that the shared passphrase does not match at least a portion of the passphrase, transmit a failure message indicating the passphrase did not match the shared passphrase to the second user device; receive, from the first user device, a request for a second passphrase for authenticating the transfer; generate the second passphrase for authenticating the transfer; transmit, to the first user device, the second passphrase for authentication of the transfer; receive, from the second user device, a second shared passphrase for authentication of the transfer; authenticate the transfer by determining whether the second shared passphrase matches at least a portion of the second passphrase; and in response to determining that the second shared passphrase matches at least a portion of the second passphrase, transfer funds from the first account to the second account.

Clause 8: The transfer verification system of clause 7, wherein the instructions are further configured to cause the transfer verification system to: in response to determining that the second shared passphrase does not match at least a portion of the second passphrase, transmit a second failure message indicating the second passphrase did not match the second shared passphrase to the second user device; receive, from the first user device, a request for a third passphrase for authenticating the transfer; generate the third passphrase for authenticating the transfer; transmit, to the first user device, the third passphrase for authentication of the transfer; receive, from the second user device, a third shared passphrase for authentication of the transfer; authenticate the transfer by determining whether the third shared passphrase matches at least a portion of the third passphrase; and in response to determining that the third shared passphrase matches at least a portion of the third passphrase, transfer funds from the first account to the second account.

Clause 9: The transfer verification system of clause 1, wherein the transfer from the first account to the second account is a first transfer request between the first account and the second account.

Clause 10: A first user device comprising: one or more processors; and memory in communication with the one or more processors and storing instructions that, when executed by the one or more processors, are configured to cause the first user device to: receive a notification of a transfer from a transfer verification system; display a first graphical user interface (GUI) comprising an account balance, a status indication associated with the transfer, and a prompt comprising a field for receiving a passphrase; receive a first passphrase for completing the transfer from a second user device via a first communication channel; receive, via field of the first GUI, user input comprising an entered passphrase for completion of the transfer; transmit the entered passphrase to the transfer verification system; receive an indication that funds associated with the transfer have transferred to an account associated with the first user device when the entered passphrase for the transfer is verified; and display a second GUI comprising the indication and an updated account balance.

Clause 11: The first user device of clause 10, wherein the instructions are further configured to cause the transfer verification system to: transmit, from the first user device, login credentials for authentication of the account; and access, from the first user device, the account when the login credentials are authenticate.

Clause 12: The first user device of clause 10, wherein the instructions are further configured to cause the transfer verification system to: receive a failure message indicating the passphrase did not match a shared passphrase; receive, from a second user device, a second passphrase for authenticating the transfer; transmit, from the second user device, the second passphrase for authenticating the transfer; and receive the funds associated with the transfer when the second passphrase for the transfer is authenticated.

Clause 13: A transfer verification system comprising: one or more processors; and memory in communication with the one or more processors and storing instructions that, when executed by the one or more processors, are configured to cause the transfer verification system to: receive, from a first user device, a request to complete a transfer from a first account to a second account; receive, from the first user device, a selected passphrase for authentication of the transfer; receive, from a second user device, a shared passphrase for authentication of the transfer; determine whether the shared passphrase matches at least a portion of the selected passphrase; and in response to determining that the shared passphrase matches at least a portion of the selected passphrase, transfer funds from the first account to the second account.

Clause 14: The transfer verification system of clause 13, wherein the instructions are further configured to cause the transfer verification system to: generate a graphical user interface (GUI) comprising a notification of the transfer; and transmit the GUI to the second user device for display.

Clause 15: The transfer verification system of clause 13, wherein the instructions are further configured to cause the transfer verification system to: determine whether the selected passphrase for authentication of the transfer meets a minimum passphrase requirement by comparing the selected passphrase to multiple passphrase requirements; in response to determining the selected passphrase does not meet the minimum passphrase requirement, generating a graphical user interface (GUI) comprising a notification that the selected passphrase does not meet the minimum passphrase requirement; and transmitting the GUI to the first user device for display.

Clause 16: The transfer verification system of clause 15, wherein the instructions are further configured to cause the transfer verification system to: receive, from the first user device, a second selected passphrase for authentication of the transfer; receive, from a second user device, a shared passphrase for authentication of the transfer; determine whether the shared passphrase matches at least a portion of the second selected passphrase; and in response to determining that the shared passphrase matches at least a portion of the second selected passphrase, transfer funds from the first account to the second account.

Clause 17: The transfer verification system of clause 13, wherein the instructions are further configured to cause the transfer verification system to: receive, from the first user device, login credentials for authentication of the first account; authenticate the first user device to access the first account by using the login credentials; receive, from the second user device, login credentials for authentication of the second account; and authenticate the second user device to access the second account by using the login credentials, wherein transferring funds from the first account to the second account is in response to the authenticating the second user device and determining whether the shared passphrase matches at least the portion of the selected passphrase

Clause 18: The transfer verification system of clause 13, wherein the instructions are further configured to cause the transfer verification system to: determine whether the selected passphrase is received within a threshold time period; and deny the transfer when the shared passphrase is not received within the threshold time period.

Clause 19: The transfer verification system of clause 13, wherein the instructions are further configured to cause the transfer verification system to: in response to determining that the shared passphrase does not match at least a portion of the selected passphrase, transmit a failure message indicating the selected passphrase did not match the shared passphrase to the second user device; receive, from the first user device, a second selected passphrase for authenticating the transfer; receive, from the second user device, a second shared passphrase for authentication of the transfer; authenticate the transfer by determining whether the second shared passphrase matches at least a portion of the second selected passphrase; and in response to determining that the second shared passphrase matches at least a portion of the second selected passphrase, transfer funds from the first account to the second account.

Clause 20: The transfer verification system of clause 19, wherein the instructions are further configured to cause the transfer verification system to: in response to determining that the second shared passphrase does not match at least a portion of the second selected passphrase, transmit a second failure message indicating the second selected passphrase did not match the second shared passphrase to the second user device; receive, from the first user device, a third selected passphrase for authenticating the transfer; receive, from the second user device, a third shared passphrase for authentication of the transfer; authenticate the transfer by determining whether the third shared passphrase matches at least a portion of the third selected passphrase; and in response to determining that the third shared passphrase matches at least a portion of the third selected passphrase, transfer funds from the first account to the second account.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all, or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A transfer verification system comprising:
one or more processors; and
memory in communication with the one or more processors and storing instructions that, when executed by the one or more processors, are configured to cause the transfer verification system to:
receive, from a first user device, a request to complete a transfer from a first account to a second account;
display a first graphical user interface (GUI) comprising a first status indication associated with the transfer;
generate a passphrase for authentication of the transfer;
transmit, to the first user device, the passphrase for authentication of the transfer;
receive, from a second user device, a shared passphrase for authentication of the transfer;
determine whether the shared passphrase matches at least a portion of the passphrase; and
in response to determining that the shared passphrase matches at least a portion of the passphrase:
transfer funds from the first account to the second account;
modify the first GUI to generate a first modified GUI comprising a second status indication associated with the transfer; and
display the first modified GUI.

2. The transfer verification system of claim 1, wherein the instructions are further configured to cause the transfer verification system to:
generate a second graphical user interface (GUI) comprising a notification of the transfer; and
transmit the second GUI to the second user device for display.

3. (canceled)

4. The transfer verification system of claim 1, wherein the instructions are further configured to cause the transfer verification system to:
receive, from the first user device, login credentials for authentication of the first account; and
authenticate the first user device to access the first account by using the login credentials.

5. The transfer verification system of claim 1, wherein the instructions are further configured to cause the transfer verification system to:
receive, from the second user device, login credentials for authentication of the second account; and
authenticate the second user device to access the second account by using the login credentials,
wherein transferring funds from the first account to the second account is in response to the authenticating the second user device and determining whether the shared passphrase matches at least the portion of the passphrase.

6. (canceled)

7. The transfer verification system of claim 1, wherein the instructions are further configured to cause the transfer verification system to:
in response to determining that the shared passphrase does not match at least a portion of the passphrase, transmit a failure message indicating the passphrase did not match the shared passphrase to the second user device;
receive, from the first user device, a request for a second passphrase for authenticating the transfer;
generate the second passphrase for authenticating the transfer;
transmit, to the first user device, the second passphrase for authentication of the transfer;
receive, from the second user device, a second shared passphrase for authentication of the transfer;
authenticate the transfer by determining whether the second shared passphrase matches at least a portion of the second passphrase; and
in response to determining that the second shared passphrase matches at least a portion of the second passphrase, transfer funds from the first account to the second account.

8. The transfer verification system of claim 7, wherein the instructions are further configured to cause the transfer verification system to:
in response to determining that the second shared passphrase does not match at least a portion of the second passphrase, transmit a second failure message indicating the second passphrase did not match the second shared passphrase to the second user device;
receive, from the first user device, a request for a third passphrase for authenticating the transfer;
generate the third passphrase for authenticating the transfer;
transmit, to the first user device, the third passphrase for authentication of the transfer;
receive, from the second user device, a third shared passphrase for authentication of the transfer;
authenticate the transfer by determining whether the third shared passphrase matches at least a portion of the third passphrase; and
in response to determining that the third shared passphrase matches at least a portion of the third passphrase, transfer funds from the first account to the second account.

9. The transfer verification system of claim 1, wherein the transfer from the first account to the second account is a first transfer request between the first account and the second account.

10. A first user device comprising:
one or more processors; and
memory in communication with the one or more processors and storing instructions that, when executed by the one or more processors, are configured to cause the first user device to:
receive a notification of a transfer from a transfer verification system;
display a first graphical user interface (GUI) comprising an account balance, a first status indication associated with the transfer, and a prompt comprising a field for receiving a passphrase;
receive a first passphrase for completing the transfer from a second user device via a first communication channel;
receive, via the field of the first GUI, user input comprising an entered passphrase for completion of the transfer;
modify the first GUI to generate a first modified GUI comprising a second status indication associated with the transfer;
display the first modified GUI;
transmit the entered passphrase to the transfer verification system;
receive an indication that funds associated with the transfer have transferred to an account associated with the first user device when the entered passphrase for the transfer is verified;
modify the first modified GUI to generate a second modified GUI comprising the second status indication and an updated account balance; and
display the second modified GUI.

11. The first user device of claim 10, wherein the instructions are further configured to cause the transfer verification system to:
transmit, from the first user device, login credentials for authentication of the account; and
access, from the first user device, the account when the login credentials are authenticated.

12. The first user device of claim 10, wherein the instructions are further configured to cause the transfer verification system to:
receive a failure message indicating the passphrase did not match a shared passphrase;
receive, from a second user device, a second passphrase for authenticating the transfer;
transmit, from the second user device, the second passphrase for authenticating the transfer; and
receive the funds associated with the transfer when the second passphrase for the transfer is authenticated.

13. A transfer verification system comprising:
one or more processors; and
memory in communication with the one or more processors and storing instructions that, when executed by the one or more processors, are configured to cause the transfer verification system to:
receive, from a first user device, a request to complete a transfer from a first account to a second account;
display a first graphical user interface (GUI) comprising a first status indication associated with the transfer;
receive, from the first user device, a selected passphrase for authentication of the transfer;
receive, from a second user device, a shared passphrase for authentication of the transfer;
determine whether the shared passphrase matches at least a portion of the selected passphrase; and
in response to determining that the shared passphrase matches at least a portion of the selected passphrase:
transfer funds from the first account to the second account;
modify the first GUI to generate a first modified GUI comprising a second status indication associated with the transfer; and
display the first modified GUI.

14. The transfer verification system of claim 13, wherein the instructions are further configured to cause the transfer verification system to:
generate a second graphical user interface (GUI) comprising a notification of the transfer; and
transmit the second GUI to the second user device for display.

15. The transfer verification system of claim 13, wherein the instructions are further configured to cause the transfer verification system to:
determine whether the selected passphrase for authentication of the transfer meets a minimum passphrase requirement by comparing the selected passphrase to multiple passphrase requirements;
in response to determining the selected passphrase does not meet the minimum passphrase requirement, modify the first GUI to generate a second modified GUI comprising a notification that the selected passphrase does not meet the minimum passphrase requirement; and
transmit the second modified GUI to the first user device for display.

16. The transfer verification system of claim 15, wherein the instructions are further configured to cause the transfer verification system to:
receive, from the first user device, a second selected passphrase for authentication of the transfer;
receive, from a second user device, a shared passphrase for authentication of the transfer;
determine whether the shared passphrase matches at least a portion of the second selected passphrase; and
in response to determining that the shared passphrase matches at least a portion of the second selected passphrase, transfer funds from the first account to the second account.

17. The transfer verification system of claim 13, wherein the instructions are further configured to cause the transfer verification system to:
receive, from the first user device, login credentials for authentication of the first account;
authenticate the first user device to access the first account by using the login credentials;
receive, from the second user device, login credentials for authentication of the second account; and
authenticate the second user device to access the second account by using the login credentials,
wherein transferring funds from the first account to the second account is in response to the authenticating the second user device and determining whether the shared passphrase matches at least the portion of the selected passphrase.

18. The transfer verification system of claim 13, wherein the instructions are further configured to cause the transfer verification system to:
determine whether the selected passphrase is received within a threshold time period; and
deny the transfer when the shared passphrase is not received within the threshold time period.

19. The transfer verification system of claim 13, wherein the instructions are further configured to cause the transfer verification system to:
in response to determining that the shared passphrase does not match at least a portion of the selected passphrase, transmit a failure message indicating the selected passphrase did not match the shared passphrase to the second user device;
receive, from the first user device, a second selected passphrase for authenticating the transfer;
receive, from the second user device, a second shared passphrase for authentication of the transfer;
authenticate the transfer by determining whether the second shared passphrase matches at least a portion of the second selected passphrase; and
in response to determining that the second shared passphrase matches at least a portion of the second selected passphrase, transfer funds from the first account to the second account.

20. The transfer verification system of claim 19, wherein the instructions are further configured to cause the transfer verification system to:
in response to determining that the second shared passphrase does not match at least a portion of the second selected passphrase, transmit a second failure message indicating the second selected passphrase did not match the second shared passphrase to the second user device;
receive, from the first user device, a third selected passphrase for authenticating the transfer;
receive, from the second user device, a third shared passphrase for authentication of the transfer;
authenticate the transfer by determining whether the third shared passphrase matches at least a portion of the third selected passphrase; and
in response to determining that the third shared passphrase matches at least a portion of the third selected passphrase, transfer funds from the first account to the second account.

21. The transfer verification system of claim 1, wherein the passphrase is generated using a random passphrase generator that creates a sequence based on a plurality of passphrase requirements.

22. The transfer verification system of claim 1, wherein determining whether the shared passphrase matches at least a portion of the passphrase comprises:
determining a number of matching characters between the shared passphrase and the passphrase; and
comparing the number of matching characters to a threshold number.
